(19) United States
(12) Patent Application Publication
(10) Pub. No.: US 2008/0257071 A1
(43) Pub. Date: Oct. 23, 2008

(54) Microfluidic Device with Porous Membrane and an Unbranched Channel

(75) Inventors: Reinhold Wimberger-Friedl, Eindhoven (NL); Christiane De Witz, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/094,849

(22) PCT Filed: Nov. 16, 2006
(86) PCT No.: PCT/IB06/54291

§ 371 Date: May 23, 2008

(30) Foreign Application Priority Data
Nov. 25, 2005 (EP) 05111308.2

(51) Int. Cl. G01N 1/00

(52) U.S. Cl. 73/863.23

(57) ABSTRACT

The invention relates to a microfluidic device for detection of a substance in a sample fluid, and to a cartridge for performing a biological assay, containing such a device. The microfluidic device comprises two housing parts (52, 54) with a porous membrane (50) there between. Each housing part has recesses, or channel parts, (56-1, 56-2, 56-n, 58-1, 58-2, 58-n) that are connected via a recess of the opposite housing part, and through the membrane (50), such that an unbranched channel is defined for the sample fluid. At one or more of the positions where the channel crosses the membrane (50), a spot (48-1, 48-2, 48-n) with an immobilized indicator substance is present, to which a target substance in the sample fluid may bind. An advantage of the present device is that in principle all of the sample fluid passes each spot. Hence there is no need to recirculate and/or mix the sample fluid, as is the case in devices with parallel flow-through paths for the fluid. The device will therefore be simpler, and give a more reliable detection result.

### FIELD OF THE INVENTION

The invention relates to a microfluidic device for performing detection of a substance in a sample fluid, the device comprising a porous membrane with a first surface and a second surface, and with a plurality of spots with at least one immobilized indicator substance, a first housing part with a first volume for holding sample fluid, and contacting the first side of the membrane, a second housing part with a second volume for holding sample fluid, and contacting the second side of the membrane.

### BACKGROUND OF THE INVENTION

Microfluidic devices are generally used to handle small amounts of fluid. In particular, in fields like molecular diagnostics biosensors et cetera, small amounts of sample fluid, such as blood or other bodily fluids, are tested on the presence of certain substances or micro-organisms, etc., often called target substances. Thereto, the sample fluid is made to contact one or more indicator substances, provided on or in the membrane in spots, that may bind to or react with those certain substances. Often, the substance or organism to be detected is made tangible via the attachment of a label, such as a fluorescent molecule. In many cases, the sample fluid is tested on many substances etc., such as antigenes. The number of spots with indicator substances is then often up to 100 or more.

In some known microfluidic devices, the indicator substances are present on or in a porous membrane, and the sample fluid is made to pass through the membrane.

In particular, U.S. Pat. No. 6,225,131 discloses a device of the kind mentioned above. The membrane comprises a large number of through-going channels. The sample fluid is pumped back and forth across the membrane in order to screen for the relevant substances.

A problem of the known device is that, on pumping the sample fluid through the membrane, each spot screens only a very small portion of the sample fluid, in a ratio of roughly the surface area of the spot divided by the surface area of the total membrane. For example, if there are 1000 spots, each spot screens only 0.1% of the sample fluid. Moreover, inhomogeneities in the membrane permeability, e.g. intrinsic or even induced by the binding of the substance to be detected, can lead to strong variations in effective screened volume per spot, since the sample fluid will follow the path of least resistance. All this may lead to inaccurate detections. In the prior art, one has tried to handle these problems by pumping the sample fluid a (large) number of times back and forth or around, most often in combination with mixing the sample fluid to homogenize it. Mixing is difficult in microfluidic channels since the flow is laminar due to the very low Reynolds number. But still no 100% screening can be achieved.

Another problem with some of the known devices is that of volume depletion. Since the volume of liquid containing the target substances inside the pores etc. is very small and the surface-to-volume ratio of the membrane is high, the effective concentration of free target substance will drop due to consumption by reaction at the surface of the pores of the membrane. This leads to a decrease of the overall rate of binding and consequently the speed of the measurement. To overcome this the liquid has to be refreshed continuously. This requires continuous pumping and mixing. The mixing has to occur outside the membrane, which leads to an increased sample volume and a more complex device.

### SUMMARY OF THE INVENTION

It is an object of the invention to provide a microfluidic device that at least in part overcomes the above-mentioned drawback. In particular, it is an object to provide a device that is able to provide improved screening of the sample fluid.

Said object is achieved with a microfluidic device as mentioned in the preamble, that is characterized in that the first volume comprises a plurality of mutually separated recessed first channel parts, and the second volume comprises a plurality of mutually separated recessed second channel parts, wherein each of the first channel parts overlaps with at most two of the second channel parts, and each of the second channel parts overlaps with at most two of the first channel parts, respectively, via an overlap area of the membrane with at least one spot, such that an unbranched channel for the sample fluid is formed in the first and second housing parts. In other words, each of the first channel parts overlaps with at most two second channel parts, and each of the second channel parts overlaps with at most two first channel parts. Each overlap takes place at the membrane, in an overlap area, one overlap area for each direct connection between a first and a second channel part, and that comprises at least one spot. Note that only the last channel part at each end of the channel overlaps with one channel part on the opposite side of the membrane, all other first and second channel parts overlap with exactly two “opposite” channel parts, i.e. second channel parts, first channel parts, respectively.

In this way, the spots that contact the first or second channel parts will screen all of the sample fluid, since the channel that carries the sample fluid passes through those spots. Hence, theoretically 100% screening may be obtained in a single step of passing the fluid through the channel once. The concentrations of target substances in the fluid remain constant throughout the total time of flow without any mixing requirement. The total flow-through time can for example be chosen as the time to flow through the total volume or the time until sufficient signal is detected (sufficient binding has taken place.) Basically, the time required to do the detection is determined by the binding kinetics of the capturing of the substances to be detected to the indicator substances, and by the detection limit of the instrument. The flow will have to be kept up until sufficient signal is developed.

It is noted that document WO2004/024327 discloses a microfluidic apparatus with a porous substrate for molecule detection, in which a number of parallel channels are present on both sides of the porous substrate. The channels overlap in such a way that each channel on a first side is always connected to all channels on the other side. Either directly, or via one or more intermediate channels, either on the same side or the opposite side of the substrate. Two or more sample fluids are inserted, that will contact at or via the substrate and cause a change in the substrate. In this apparatus, the sample fluid will flow along various parallel paths, and hence it cannot be guaranteed that the sample fluid will pass each spot (if present) in the same amount.

In the present invention, all the channel parts together form a channel through which the sample fluid passes the membrane in one step. Then, all the spots present on a connection between the first volume and the second volume will receive the same amount of sample fluid, which will greatly improve the accuracy of the detection of substances with the spots. Note that it is not necessary for all of the spots to be present in a channel. It suffices if a plurality of spots is present in the channel, and thus will receive all of the sample fluid. Other spots may be provided in a different fashion, e.g. according to the prior art device as a group of spots on a membrane area, through which the sample fluid flows in a more or less parallel fashion. In principle, by providing one channel for the sample fluid, the cross-sectional area is reduced, with the result that, all other factors remaining the same, the total flow-through time would be increased by the same factor as compared to a single passage in the parallel flow-through device. However, a number of factors mitigate this. First of all, a single run through the membrane suffices. Furthermore, a much smaller sample volume can be used due the omission of external circulation and mixing. By confining the sample fluid inside microchannels it is straightforward to have multiple samples flow through the same membrane in parallel without interference. This is important in the case that multiple PCR products need to be analyzed. In this way the sample volume is reduced drastically and consequently the screening time, but more importantly cross reactivity problems are avoided or greatly reduced. The maximum flow-through time may be determined by the total sample volume and the maximum flow rate of the fluid inside the membrane which is acceptable and/or desirable. The first depends on the application, and the second on the microstructure of the membrane. Increasing the flow rate increases the required pressure drop to maintain the flow. The pressure on the membrane increases accordingly. In the device according to the invention, the membrane can be supported by the bottom and top substrate very well, as will be explained further below. This is in contrast to the parallel flow through as in the known device.

Note that each spot is between one channel part of the first volume and one channel part of the second volume. Note furthermore that no mixing or recirculating around or back-and-forth is needed in order to obtain this screening.

A further advantage is that the total volume of the device that is available for the sample fluid may be reduced, since e.g. no mixing chamber or (re)circulation chamber is required.

Another advantage is that the building height, or thickness, of the total device may be reduced, since the flow is now no longer from one large volume on one side of the membrane to another large volume on the other side. Only a very small height suffices. This small height, or thickness, allows an improved read-out of the spots of the membrane.

Note that the recessed parts have a volume with respect to an outer surface of the respective housing part. One could also say that the volume is defined in combination with the membrane, that covers the channel parts.

One could say that a chief goal, though not necessarily the only one, of the device is to detect a large number of different molecules present in an often very low concentration in a sample fluid, not only quickly but with high sensitivity and reproducibility.

In a particular embodiment, the first and second housing parts each comprise at least 10 channel parts. This indicates that the channel, and thus the path of the sample fluid therein, will cross the membrane at least 10 times, offering an at least equal number of positions for providing a spot.

At each of the above mentioned crossings, a spot may be provided for detecting some substance in the sample fluid. In a particular embodiment, the membrane comprises at least 10 spots, and each spot is contacted by one channel part of the first volume and by one channel part of the second volume. Of course, it is not necessary to provide such a spot on or in the membrane at each connection between a channel part of the first volume and a channel part of the second volume, and any other number may also be used. Furthermore, it is also possible to provide more than one spot on or in the membrane at such a connection.

In a particular embodiment, the device comprises at least two separate channels. This may for example be embodied in that the sample fluid is distributed over more than one channel, wherein of course each channel crosses the membrane two or more times. This can provide parallel flow paths. Each channel has its own sample fluid inlet, in particular connected to its own sample fluid container. This ensures that similar amounts, or at least known amounts, of sample fluid may pass through each channel, and that mixing between the channels does not occur, which would be a cause for inaccuracies. It is also possible to provide different sample fluids, that is, with different target substances to be detected. This may be useful when those different sample fluids need to be treated in a similar fashion before the measurement can be carried out.

In the case of a single channel, this is often a winding channel, in order to achieve a long channel length with many spots with a small total surface area of the device. However, in the case of multiple channels, it may be advantageous, though not necessary, to provide those multiple channels in parallel.

In a special embodiment, the first and second housing parts each comprise a structured component that defines the respective channel parts. In this embodiment, the housing part comprises two component in which the channel parts have been machined. The structures in the component will very often be very small, and the techniques used to machine the structures may for example be those of the field of lithography. As an exemplary starting point, lithographic exposure and development of a patterned resist on a glass or silicon substrate is followed by transfer into a mold material, like nickel by electroplating or the like. This in turn is followed by replication of the structure into e.g. a polymer by injection molding, embossing, etc. Similar technology is used to produce Compact Discs. The number and size of the spots can be varied in a very broad range depending on the application technology, such as printing, without approaching the limits of microstructuring the housing parts by (photo)lithography or replication techniques. Of course, other techniques, for example based on laser cutting, may also be used.

In a particular embodiment, the structured component comprises a generally flat surface in which the channel parts are left out as recesses. Herein, the expression “generally flat” relates to the unmachined surface without the recesses, and after machining relates to the unmachined parts of the surface. It is however not necessary for the surface to be absolutely flat, since the membrane will often be able to close off recesses even in a somewhat curved or irregular surface. For example, it is possible to provide ridges between channel parts in a housing part, in order to improve the sealing of the channel(s) against the membrane.

In a special embodiment, the first and second housing parts are provided connected under pressure, such that the membrane is in a compressed condition in an area that contacts both the first and the second housing parts. This ensures a good fixing of the membrane between the housing parts, which in turn ensures that correct positions of the spots with respect to the channel parts may be maintained. Compressing of the membrane further ensures a good sealing of the channel and channel parts, minimizing undesired bypass of sample fluid. Herein, the membrane may cover the edges of the channel parts, and can even extend over the outer edges of the housing parts, although the latter is not necessary. In some cases, it may even be advantageous to provide the membrane within the outer edges of the housing parts, for example to prevent contamination. This may be embodied by providing the channel parts sufficiently far removed from the outer edges of the housing parts.

In a particular embodiment, an adhesive is provided between the membrane and the generally flat surface of at least one of the first and second housing parts. The adhesive additionally helps in sealing the channel against undesired bypassing of sample fluid. The adhesive may be applied on the membrane, e.g. all around the spots, or on all or a part of the membrane that contacts the flat surface of the first and/or the second housing part. Alternatively or additionally, the adhesive may also be applied on one or both of the housing parts, on the flat surface thereof that contacts the membrane. Of course, it is preferred that the adhesive does not contact the spots, to prevent contamination or undesired increase of flow resistance.

A consequence of the membrane being fixedly provided between the first and second housing parts, by compressed fixation and/or by providing adhesive, is that the membrane is fixed from all sides surrounding the channel (parts) and consequently can only deform by (biaxial) stretching. That ensures that the membrane shows a good resistance against forces exerted by the sample fluid flow.

In a special embodiment, the device further comprises a sample fluid inlet in contact with one of the first and second volumes. Especially in a case wherein the microfluidic device is intended to be reused, it is advantageous to provide a separate sample fluid inlet. Even when the device is intended for single use, such separate fluid inlet offers advantages. However, it is also possible to provide a penetratable wall part in a housing part, which may be penetrated by e.g. a syringe. It is of course advantageous if said penetratable wall part is self-sealing after the syringe etc. has been retracted.

In a particular embodiment, the device comprises a sample fluid container. In this container, the sample fluid may be stored, e.g. until the moment of measuring, until conditions such as temperature have been set, etc. The container is contactable to the channel, to enable the sample fluid to flow through the channel. When the sample fluid container is contacted to the channel, the container more or less is a part of the first or second volume. It is possible to provide a sample fluid container at both ends of the or each channel, wherein the sample fluid may be pumped from one container to the other. Alternatively, at the channel end opposite the sample fluid container, there may be provided a waist valve, through which the used sample fluid may be discharged.

Expediently, the channel is contactable to a holder of an additional fluid. This allows the possibility to pump an additional fluid through the channel, which will remove the original sample fluid. This may provide a better background for assessing the spots on or in the membrane. A certain type of such additional fluid could be a gas such as air.

In a particular embodiment, the device further comprises a sample fluid pump. Such a sample fluid pump may be used to drive the sample fluid through the channel. The pump may be any type of fluid pump, for example based on piezo-electrically moveable parts, rotary pumps, and so on. Note that the pump may also be provided externally, such that the pressure or other driving force as exerted by the pump is transported to the sample fluid in the device.

In a special embodiment, at least one of the first and second housing parts comprises an optical element, preferably as an integral part of said at least one of the first and second housing parts. The microfluidic device serves to detect substances in a sample fluid, by passing the sample fluid through a membrane with spots. Subsequently, the spots are inspected to determine whether or not the sample fluid actually contained the substance(s) that was(/were) to be detected by the respective spot(s). Providing an optical element may assist in surveying the spots. In particular, the optical element comprises an optical window or a lens array. This may allow a clear view with sufficient resolution of the membrane with the spots, and even with a kind of magnification by the lenses if desired. The optical element may be provided as an integral part of the first and/or second housing part. For example, the housing part may itself be made of an optically transparent material, and a part of the housing part may be provided in the shape of an optical element such as a lens. Of course, it is also possible to remove the membrane from the device in order to check the spots.

The device may further comprise an optically sensitive read-out device that is able to obtain an optical signal from at least one of the spots. This allows optimum adaptation of the device to the characteristics of the substance(s) to be detected. Such an optically sensitive read-out device may be a photometer, a calorimeter, etc. It is of course also possible to provide a system, comprising a separate device according to the invention and a separate read-out device.

The invention also provides a cartridge for performing an assay, comprising a device according to the invention. In particular, the device further comprises at least one sample preparation device, in particular a cell filtration device, a cell lysis device, a DNA extraction device or an amplification device. Optionally, the device may also comprise a heating device. A great advantage of such a combined device is that various other steps in the detection of relevant substances may be performed inside the device, which minimizes the risk of contamination. The various other parts required or desired to carry out the other incorporated functions may be positioned suitable on or in the device, such as in separate sealable chambers etc. To perform the functions, it may be advantageous to provide a connection to a control unit, for example a computer, or incorporate such a control unit into the device.

### BRIEF DESCRIPTION OF THE DRAWINGS

These and other aspects of the invention are apparent from and will be elucidated with reference to the embodiments described hereinafter.

In the drawings:

FIG. 1 shows a diagrammatical cross-sectional view of a prior art device.

FIG. 2 shows a top view of the membrane 12 in the device of FIG. 1.

FIG. 3 diagrammatically shows an embodiment of the microfluidic device according to the invention.

FIG. 4 shows a cross-sectional view of the device of FIG. 3.

### DETAILED DESCRIPTION OF THE PREFERRED EMBODIMENTS

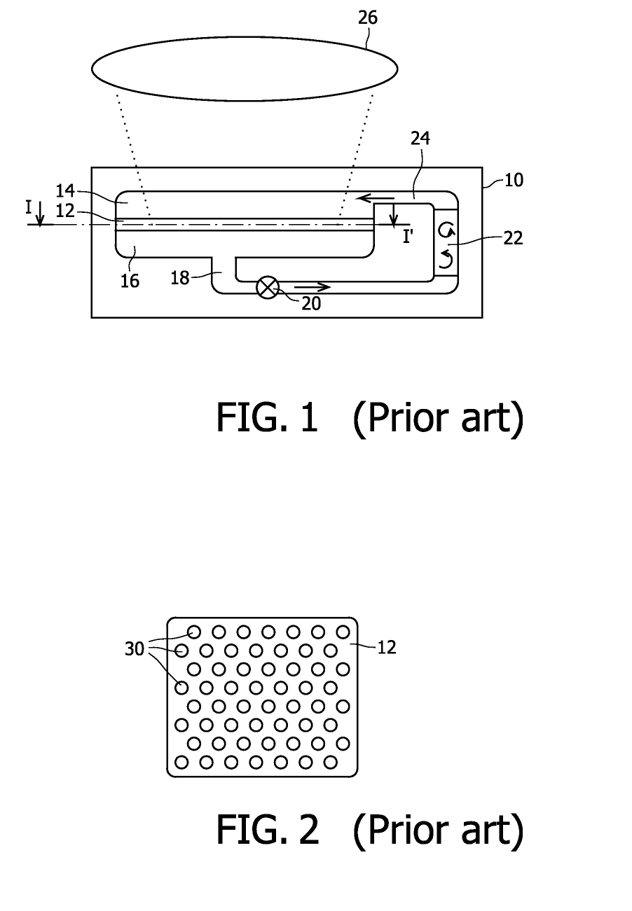

FIG. 1 shows a diagrammatical cross-sectional view of a prior art device. Herein, the device comprises a housing 10, with a membrane 12, contacted by a first volume 14 and a second volume 16. Via a drain 18, a pump 20 pumps fluid in the direction of the arrow towards mixer 22, and from there, via feed 24 into the first volume 14.

An optical inspection device is indicated very diagrammatically by reference numeral 26.

In the prior art device shown here, the sample fluid is pumped through the membrane 12, into or onto which one or more indicator substances have been applied in so-called spots. When the sample fluid passes the membrane, the fluid will contact the indicator substances, and depending on the composition of the fluid, one or more of those indicator substances will either bind to a part of the fluid or undergo some change, in both cases indicating the presence of some substance, micro-organism etc. in the sample fluid.

In the device shown, only a small part of the sample fluid will pass each individual spot, in a ratio of roughly the surface area of the spot divided by the surface area of the total membrane 12. To improve screening, the sample fluid is sometimes made to pass the membrane 12 a number of times, by pumping back-and-forth, or by pumping around a number of times, sometimes assisted by a mixer 22, in which the fluid is mixed. Note that mixing hardly occurs in the microfluidic channels, such as 18, 24 and the microchannels in the membrane 12.

FIG. 2 shows a top view of the membrane 12 in the device of FIG. 1, taken along the line I-I′. Indicated are a number of spots 30. Each of the spots comprises an indicator substance as described above. The number of spots may vary, and may be any number, such as 1, 2 etc., but is most often a rather large number, such as between 100 and 1000. In the case shown, this number has been limited to 56, for the sake of simplicity of the drawing.

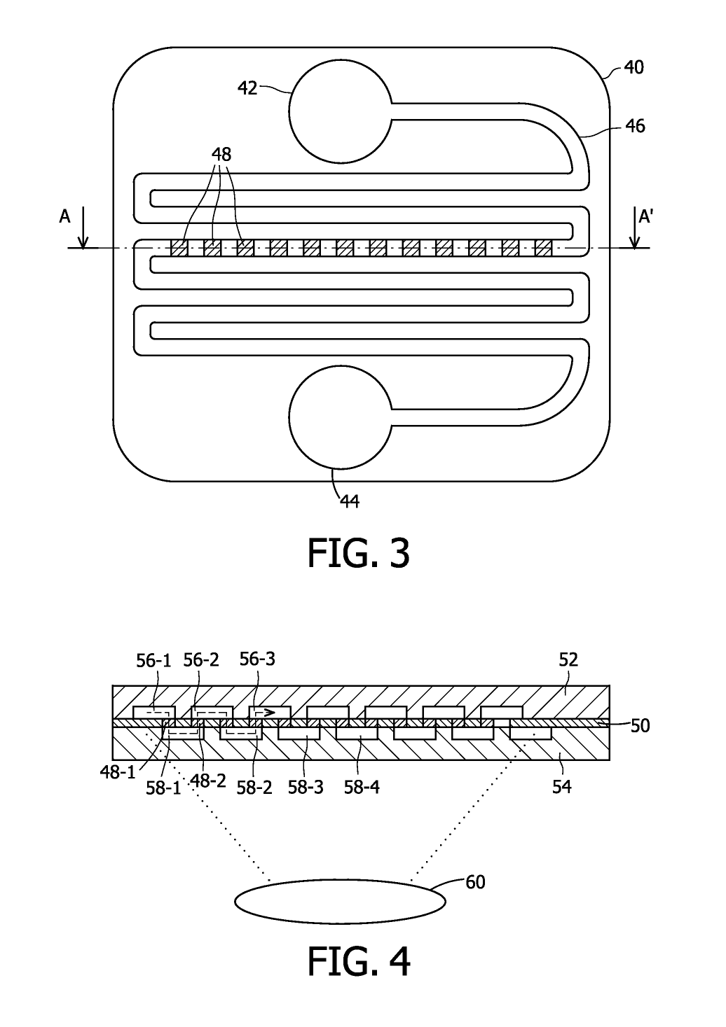

FIG. 3 diagrammatically shows an embodiment of the microfluidic device according to the invention.

Herein, in a housing 40, there are provided an inlet 42 and an outlet 44, connected by a channel 46, in which spots 48 of indicator substance have been provided.

The channel 46 is a winding channel, in order to provide a large channel length on a small surface area. The spots 48 are present in each of the 6 parallel tracks of the channel 46, although they are shown in only one such track.

The inlet 42 and the outlet 44 may also be sample fluid containers, in which the fresh sample fluid, the used sample fluid, respectively, may be stored.

It is also possible to provide a number of separate channels 46, each with their own inlet and outlet. Such channels could run parallel, or not, and may be used to perform parallel detections, or sequential detections, on similar or dissimilar sample fluids. Each channel may be connectible to a pump means, and may be separately controllable by a control unit (not shown). Each channel may have its own selected spots with selected indicator substances.

FIG. 4 shows a cross-sectional view of the device of FIG. 3, along the line A-A′. Here, a membrane 50, with spots 48-1, 48-2, etc., (referred to as 48-n) is held between a first housing part, here also called an upper membrane holder part or cover 52, with a number of upper channel parts 56-1, 56-2, etc., (referred to as 56-n) and a second housing part, here also called a lower membrane holder part or substrate 54 with a number of lower channel parts 58-1, 58-2, etc.(referred to as 58-n). An optical device is indicated diagrammatically with reference numeral 60. Please note that the indication “lower” or “upper” is not used to indicate some preferred orientation, but simply to be able to refer unambiguously to parts shown in the drawing. In reality, the device would work equally well when turned upside down, or rotated over any angle.

The membrane 50 may be any suitable porous membrane, such as a membrane intended for biological arrays. Such a membrane may comprise mutually parallel flow-through capillaries, such as may be made in silicon or alumina, or may comprise an isotropic network of mutually connected capillaries, such as may be made of e.g. isotropic nylon.

The inlet 42 and/or the outlet 44 may comprise a connection to some other, external or internal sample fluid holder, or comprise a sample fluid holder themselves. In the latter case, the device as a whole is very suitable for single use, and the holder may comprise a wall that can be penetrated by e.g. a syringe for injection of some sample fluid, containing one or more substances, organisms, etc., to be detected.

The inlet 42 and outlet 44 are connected by means of a channel 46, that winds in order to have a large length. The inner volume of the channel 46 crosses the membrane 50 a plurality of times, as can be seen in FIG. 4. Thus, a winding path for the sample fluid arises, a part of which has been indicated by the dashed arrow. The first channel parts 56 and the second channel parts 58 overlap in overlap areas on the membrane 50 in order to form the channel 46. Each of the first and second channel parts overlaps with two channel parts on the opposite side of the membrane 50, with the exception of each of the two last channel parts at the ends of the channel 46, that overlap with only one such “opposite” channel part. In this case, assuming that the channel 46 consists of the channel parts shown in FIG. 4, one can see that first channel part 56-1 overlaps with a single second channel part, while e.g. 56-2, 56-3 etc. overlap with two second channel parts each.

The functioning of the device according to the invention is explained in FIG. 4. A sample fluid arriving in the leftmost upper channel part 56-1, or recess-like structure, in the upper membrane holder part 52, is being pumped in the direction of the dashed arrow by some pump means, which has not been indicated, but corresponds to e.g. pump 20 in FIG. 1. Under the influence of the pressure exerted by the pump means, or simply by capillary action, the sample fluid will cross the membrane 50, and reach the leftmost lower channel part 58-1. In crossing the membrane 50, the sample fluid will contact the first spot 48-1, that comprises some indicator substance, e.g. a biological capture probe that will bind a desired molecular species, if present in the sample fluid.

Subsequently, the sample fluid is pumped further, through second spot 48-2 on or in the membrane 50, towards the one but leftmost upper channel part 56-2. The second spot may comprise a similar or different indicator substance.

In a similar fashion, the sample fluid will pass each further spot 48-3, etc. (referred to as 48-n) until the fluid reaches the outlet 44 of the channel 46, both of which as indicated in FIG. 3. It can be seen that all of the sample fluid, obviously apart from substances etc. bound to one or more spots, thus passes each of the spots 48-1, 48-2 etc. The whole process may take place in a device with a very small thickness. This allows a better resolution, as obtained by the optical device 60, which in turn means that the spots 48, and thus the channel 46 and the device as a whole, may be made smaller.

The shape of the upper and lower channel parts is not particularly limited and can be adopted as desired for easy fabrication, optimized flow etc, as long as the path of the sample fluid is through the spots 48 on or in the membrane 50. This ensures that the indicator substances in the spots 48 will perform their function.

The spot sizes which may be used are not limited. Spots with a diameter between 50 and 500 micron diameter are most preferred. This can be reduced further if the printing of the indicator substances on the membrane is controlled well enough. The size is also often chosen to fit to the detection optics. A larger spot gives more signal due to light scattering in the case of imaging. With a scanning optical read out, this is no issue and the spot size could be further reduced. In the FIGS. 3 and 4, the spots are shown to be as large as the overlap area of each direct connection between a first and second channel part. In practice, the spots 48 may be chosen to be slightly smaller, to ensure that the sample fluid can pass the spot in a correct way, without a too large risk of blocking at the sides of the spot.

The dimension of the channel 46, and of the passages in the upper and lower channel parts 56 and 58 and the passages there between through the membrane 50, is designed to fit to the spot size (e.g. between 150 and 400 micron in width) and is not limited by technology, meaning much smaller or larger dimensions can be made easily. The channel height will be of the same order of magnitude. The flow resistance should preferably not be determined by the channel but rather by the membrane. Therefore the ‘free’ channel height above and below the membrane will often be in the order of tens of microns, although other, and in particular larger, values are not excluded. Typical values would be between 50-100 μm. The membrane height will often be in the order of 10 to 150 microns. The principle can be implemented more easily with thin membranes.

Note that the membrane 50 comprises at least one through-going passageway, capillary or the like for each spot. In some cases, the membrane will comprise a large number of microscopic channels for each spot, not to be mistaken for the channel 46 for the sample fluid as a whole. The indicator substance may be provided on an outer surface of the substrate 12, or may be provided in the membrane itself, e.g. on the walls of the through-going channels, and so on. The indicator substance may have been provided by any known technique, such as impregnating, and especially by printing.

In the device shown, the spots are provided in a regular pattern, although this is not necessary, and e.g. with printing technology, any spot distribution is easily obtained. The indicator substances may each be a different substance, or may for example have the same substance in a different concentration. Also, two or more spots may comprise the same substance with the same concentration, in order to increase the contact area with the sample fluid for that substance.

1. A microfluidic device for performing detection of a substance in a sample fluid, the device comprising
a porous membrane, with a first surface and a second surface, and with a plurality of spots with at least one immobilized indicator substance;
a first housing part with a first volume for sample fluid, and contacting the first side of the membrane;
a second housing part with a second volume for sample fluid, and contacting the second side of the membrane;
characterized in that the first volume comprises a plurality of mutually separated recessed first channel parts and the second volume comprises a plurality of mutually separated recessed second channel parts, wherein each of the first channel parts overlaps with at most two of the second channel parts and each of the second channel parts overlaps with at most two of the first channel parts, respectively, via an overlap area of the membrane with at least one spot such that an unbranched channel for the sample fluid is formed in the first and second housing parts.

2. The device according to claim 1, wherein the first and second housing parts each comprise at least 10 channel parts.

3. The device according to claim 1, wherein the membrane comprises at least 10 spots, and wherein each spot is contacted by one channel part of the first volume and by one channel part of the second volume.

4. The device according to claim 1, comprising at least two mutually separate channels.

5. The device according to claim 1, wherein the first and second housing parts each comprise a structured component that defines the respective channel parts.

6. The device according to claim 1, wherein the first and second housing parts are provided connected under pressure, such that the membrane is in a compressed condition in an area that contacts both the first and the second housing parts.

7. The device according to claim 6, wherein an adhesive is provided between the membrane and the generally flat surface of at least one of the first and second housing parts.

8. The device according to claim 1, further comprising a sample fluid inlet in contact with one of the first and second volumes, and wherein preferably the channel is contactable to a holder of an additional fluid.

9. The device according to claim 1, further comprising a sample fluid container.

10. The device according to claim 1, wherein at least one of the first and second housing parts comprises an optical element,

11. The device according to claim 1, further comprising an optically sensitive read-out device that is able to obtain an optical signal from at least one of the spots.

12. A cartridge for performing at least one biological assay, comprising a device according to claim 1.

13. The cartridge of claim 12, further comprising at least one sample preparation device, in particular a cell filtration device, a cell lysis device, a DNA extraction device or an amplification device.

14. The cartridge of claim 12, further comprising a heating device.
